(19) United States
(12) Patent Application Publication
(10) Pub. No.: US 2013/0174222 A1
(43) Pub. Date: Jul. 4, 2013

(54) METHOD AND APPARATUS FOR AN EPHEMERAL TRUSTED DEVICE

(71) Applicant: Ronald Roy Ogle, Carmel, IN (US)

(72) Inventor: Ronald Roy Ogle, Carmel, IN (US)

(73) Assignee: THOMSON LICENSING, Issy de Moulineaux (FR)

(21) Appl. No.: 13/822,401

(22) PCT Filed: Sep. 13, 2011
(86) PCT No.: PCT/US11/51292

§ 371 Date: Mar. 12, 2013

Related U.S. Application Data
(60) Provisional application No. 61/382,402, filed on Sep. 13, 2010.

(51) Int. Cl. G06F 21/31

(52) U.S. Cl. CPC G06F 21/31
USPC 726/3

(57) ABSTRACT

A method and system is performed by a requesting apparatus for accessing protected content from a content provider. The method includes receiving an indication of a level of trust needed to access specific protected content from a content provider, and supplying an identity attestation and an attribute attestation and the received level of trust to a third party evaluator. The evaluator determines if the requesting apparatus meets the level of trust needed to access the protected content. A trust attestation is generated indicating a level of trust of the requesting apparatus and is sent to the requesting device. The trust attestation is evaluated by the requesting device to determine what version of the protected content can be downloaded from a content provider. The requesting apparatus then asks for the protected content if the trust level attestation meets the level of trust needed to access the specific content from the content provider.

### CROSS REFERENCE TO RELATED APPLICATIONS

This application claims priority to U.S. Provisional Application No. 61/382,402 entitled “Ephemeral Trusted Devices”, filed on 13 Sep. 2010, which is hereby incorporated by reference in its entirety.

### FIELD

The present invention relates to content security, and in particular, security for content to be loaded into a media device.

### BACKGROUND

Content providers generally only deliver their content to authorized receivers. In one current mode of operation, content providers contract with equipment providers to design specific hardware in order to maintain secure delivery of content from the provider to the user. This equipment enables the content provider a secure or trusted system that can deliver content securely and reliably to a user. Breaches in security can cause the content to become available to thieves. Such piracy can diminish the value of the content considerably due to uncontrolled distribution or misuse. To avoid this, content providers have used specialized and proprietary trusted hardware content delivery systems. These systems can be expensive and close out the content providers to using alternative delivery systems which may be available.

In using such a proprietary trusted hardware system, both the equipment provider and the end user must abide by the system content provider's terms, conditions, and limitations. The primary reason why the current systems are proprietary is that it allows the content provider to ensure a degree of trusted security with relation to their delivered content. Essentially the content providers can completely pre-determine the trustworthiness of the receiving equipment, the configuration, and the software applications so the downloaded content is maintained in a secure manner.

In order to provide this trust, the hardware system must be proprietary and enforced by the provider of the system. One problem is that content providers and end users are constrained with the equipment provider's dedicated hardware solution. Content providers are thus constrained by their contracted hardware solution vendors, users are constrained by the authorized equipment that they can use, and other, non-contract equipment providers can be shut out of the market to sell compatible equipment for content playback from specific content providers. In addition, the hardware solution vendors or manufacturer of the media device are under pressure to keep their product secure even after the sale. But, such security upgrades are difficult to accommodate in fixed solution systems. Alternative solutions offering alternative sources of hardware systems would be useful.

Another observation is that security is always evolving. As the practice of hacking evolves, new classes of vulnerabilities will be created that previously unknown. A system that is adaptable to newly discovered vulnerabilities would benefit content providers by addressing solutions to newly discovered vulnerabilities.

### SUMMARY

To present invention addresses the above mentioned security vulnerabilities in an adaptable user media device that uses an ephemeral trust system that can evaluate a user media device real-time against all presently known vulnerabilities. Therefore, a content provider is assured that the content can be delivered to a user device that is safe against known vulnerabilities.

The invention establishes ephemeral trusted devices that can allow media equipment manufacturers to provide different equipment compatible with protected content provider's specifications without being a dedicated proprietary media equipment manufacturer. Thus, users of the different media equipment can purchase and use media equipment that can function with content providers and have additional features allowing users more flexibility in configuring and adding applications to the media equipment.

This is accomplished by allowing the content providers to have media equipment verification via third parties (independent and trusted evaluators) so that the media equipment can be trusted, and therefore, the downloaded content will be safe from unauthorized use. This opens the possibility of choice for end users to buy equipment that they desire with the features that they want. It will also allow the content providers to open their content to the end users on terms and conditions that they still specify to ensure the security of their delivered content.

Aspects of the invention include obtaining a newly-evaluated trust level of the content-requesting media device when it requests content. In this manner, the content requesting device is always verified anew each time that content is requested. This aspect provides the content provider a higher level of assurance than is currently possible because a new security vulnerability can be immediately protected against by evaluating the user device against the new vulnerability and lowering the security level of the now-vulnerable media device in real-time as the transaction is processed. Thus, high grade content is prevented from being delivered to a user media device that is assessed at a lower trust level because of a new security vulnerability.

In one embodiment, a method performed by an apparatus for accessing protected content from a content provider, includes receiving an indication of a level of trust needed to access specific content from a content provider, supplying an identity attestation and an attribute attestation and the received level of trust to a trust level evaluator, receiving from the trust evaluator a trust level attestation, determining, whether the specific content can be requested based on the trust level attestation, and requesting by the apparatus the specific content if the trust level attestation meets the level of trust needed to access the specific content from the content provider. If the media device does not possess the level of trust needed for the specific requested content, then an alternate mode or version of the content commensurate with the level of trust possessed by the may be downloaded. Alternately, if the trust level of the media device is too low to download the full specified content, then the media device can be optionally upgraded or reconfigured to elevate the level of trust of the media device if the upgrade is possible. Another subsequent evaluation by the trust level evaluator may then allow the media device to acquire the specific content.

Additional features and advantages of the invention will be made apparent from the following detailed description of illustrative embodiments which proceeds with reference to the accompanying figures.

### BRIEF DESCRIPTION OF THE DRAWINGS

FIG. 1 depicts an media device in a system according to aspects of the invention;

FIG. 2 depicts a first of three transaction flow diagrams according to aspects of the invention;

FIG. 3 depicts a second of three transaction flow diagrams according to aspects of the invention; and

FIG. 4 depicts a third of three transaction flow diagrams according to aspects of the invention.

### DETAILED DISCUSSION OF THE EMBODIMENTS

Ephemeral trust as used herein is the concept that security trustworthiness of a device can change over time and that trust level should be evaluated on demand for specific purposes. The trust of a device is related to the design/implementation of the device, the configuration, and applications that are loaded. All of these items can be altered and/or found to be exploitable over time.

External content providers should have a way of evaluating whether or not a specific device is allowed to view and/or use their content based upon the evaluated trust level at that moment in time. Ephemeral trust provides the means for a trusted third party to evaluate the level of trust of a device at any specific time so that a decision can be made to allow or deny any type of content or to allow a degraded version of that content to be downloaded to that device if a downgraded version of the content is available. Thus, for instance, if a media device is requesting content from a content provider, the device would seek an attestation of trust for the desired content from a third party evaluator. Such an attestation of trust can take many forms such as but not limed to messages, certificates, tokens, or any other means to signify a certification of a statement about some characteristic of a device. In one embodiment, multiple types of attestations can be combined into a message or a certificate. Device characteristics may include one or more parameters such as identity, capabilities, configuration, versions of hardware or software, or other status. The third party evaluator is trusted by both the content provider and the media device separately. This way, information about the media device need not be provided directly to the content provider. Likewise information about the exact content that is requested need not be provided to the third party evaluator.

Some exemplary aspects of the related to the present invention include the potential establishment of ephemeral trust standards useful to content providers for matching up trust levels with specific content. Such standards would define trust levels, define security requirements for a device to meet at a specific level of trust and may define the processes involved in an ephemeral trust related flow. Using such standards, content providers could match up their various grades of content with suitable levels of standardized trust levels. Also, using standardized levels of trust, device manufacturers can design devices for a target trust level by meeting the standards. Such device manufacturers would design and manufacture media devices that can embed or download security keys and generate device identity attestation messages, such as identity certificates. Manufacturers of these media devices can then test their devices to ensure that the devices meet the standard trust levels. Any user can purchase the devices and content providers can enforce content security according to the security level of the purchased device by only allowing the devices to render content at a specified security level. Manufacturers can also offer users security level upgrades to their devices as needed to correct vulnerabilities or to add functionality. Such functionality can increase a media device's maximum level of trust to securely accommodate higher grades of content. It is also be possible to lower the maximum level of trust because of the added functionality. As a possibly separate entity, attestation providers can provide both identification attestations having device type information and attribute attestations that provide a media device status as to how it is configured. Manufacturers can use such attestation providers, such as certificate providers, to certify the manufactured media devices meet the trust level standards. Security keys and certificates can be provided to all parties as needed for secure and verifiable transactions as is well known by those of skill in the art. Trusted third parties can be called upon by users or content providers to evaluate a media device trust level. Such third party evaluators can use external resources to verify if there are any known vulnerabilities to a configuration, software load, or application of a particular media device. In one embodiment, these trusted third party evaluators can provide recommendations to end users to update or fix trust levels of compromised devices.

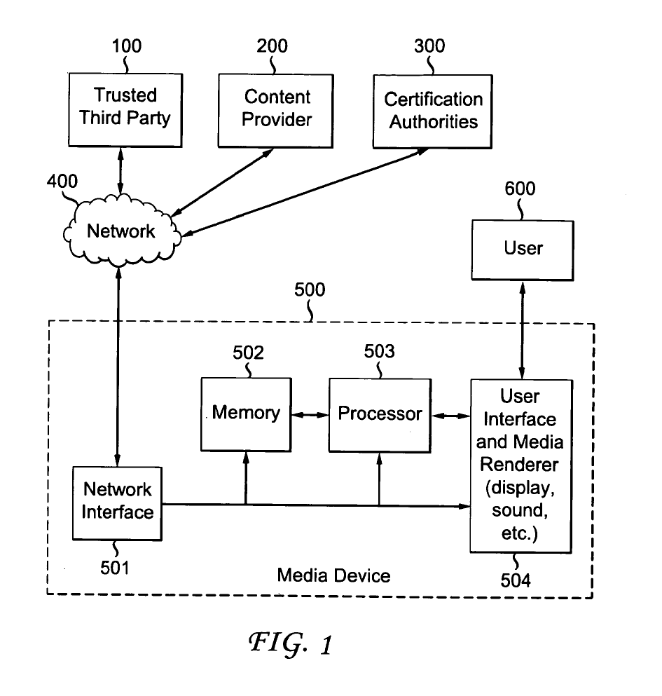

FIG. 1 depicts one example environment within which the preset invention may be performed. Entities depicted in FIG. 1 include a trusted party 100 (trust level evaluator), content provider 200, certification authorities 300, a network 400, an media device 500, and a user 600. The trusted third party 100 is an entity that is trusted for timely, efficient, and accurate evaluations of trust levels versus capabilities of media devices 500, the trusted third party may also be informed of the practices of hackers, and such in order to evaluate vulnerabilities in media devices. The content provider 200 relies upon the trusted third party 100 to provide evaluation services. In alternate embodiments, the trusted third party evaluator may be part of the content provider, the certification authority, an media device manufacturer, or a network service provider supporting the network 400. The content provider 200 provides content that it wishes to protect from unauthorized copying, sharing, or other forms of piracy, and establishes a level of trust associated with specific content offerings. As an aspect of the invention, the media device may only have access to specific content from the content provider if the media device meets the level of trust required for the specified content. The content provider 200 relies on the trusted third party 100 to evaluate the media device 500 prior to specific content delivery. Certification authorities 300 provide certificates and encryption keys to a manufacturer (not shown) of the media device, content providers, trusted third parties, and network service providers as needed. The network 400 may be a public or private network as is known to those of skill in the art. Examples include various forms of public and private Intranets or Internet networks. The media device 500 may be a device such as a personal computer (PC), a personal digital assistant (PDA), or other media device, such as an audio and/or video recorder or player or other type of device that are known by public and private users to access, render, or store media information such as pictures, files, video, audio, text, and the like from media sources such as content providers. For simplicity of reference, the media device is termed a media device but is understood to include all media devices, embedded to stand-alone, known to those of skill in the art. The user 600 can be an individual person or a collection of persons representing any group such as a family or a corporation for example. An end user 600 may also be an electronic device that consumes content in an authorized manner.

Overall, the ephemeral trust level of a media device is evaluated using the following aspects. The media device which is requesting content identifies itself to a third party evaluator. This allows a third party evaluator to know the type of media device that is requesting content. This device type information helps the third party define the inherent level of trust built into the product at the time of manufacturing. The media device also provides additional attributes that identify the present software, hardware configuration, and/or applications that are in the device. This information also includes capabilities so that the content provider knows how and/or what format in which to deliver the content. With the media device type information and the additional attribute information, the third party can now make a determination based upon the media device's information and external sources to evaluate and provide a determination of the trust level to which the media device can be certified. The content provider can now evaluate, based upon the trust level certification that it received via either the media device via the third party or via the third party directly, whether the requested content can be provided to the media device, a degraded version of the requested content can be provided instead, or no content can be provided Likewise, the end user can evaluate whether or not to continue the transaction or chose a degraded version of the requested content.

The media device, the status and configuration of the media device, and the evaluation by a third party assist in defining the ephemeral trusted device concept. There are multiple levels of trust from 1 to X where 1 is a low level of trust and X is a high level of trust. The expectation is that the state of practice for hacking will evolve finding new vulnerabilities or even new classes of attacks over time; therefore, the evaluation of any given media device's trust level may degrade over this same time unless the weaknesses can be fixed or mitigated. While there can be multiple trust levels that can be defined, a good example of three is instructive. For example, we could define low, medium, and high or 1. 2, and 3 respectively, for example. The low level of trust is equivalent to a standard PC. The medium level of trust would allow for standard definition video that is not very valuable, such as re-runs. The high level trust example is equated to the high-end proprietary devices capable of receiving the most valuable content such as, for example, pay per view. Of course, many such levels can be established within the spirit of the invention. The low level security requirements would be at a minimum level of security, while the high level security requirements would be state of the practice for valuable content. The exact levels can be defined by the content provider in order to define the many trust levels needed to distribute the varied content that providers have. Alternately, the levels of trust can be defined by some external entity or standard to establish a point of comparison.

In one possible embodiment, the trust level requirements are defined in standards for manufacturers so that they can design devices to meet the intended level of trust and can be evaluated and verified by third parties. The trust levels provide content providers assurances at the different levels for specific values of content that can be protected where the lowest level is good for content of low value and the highest level is good for the highest value.

In one embodiment, media devices meet the following requirements. Each media device will be required to contain a device-unique set of signature keys and one or more attestations to uniquely identify the media device. The identity attestation will be signed by an approved Certification Authority (300). In one example the authority can be a certificate authority if the attestations take the form of a certificate. In addition, each media device shall identify its status via attribute attestations or configuration attestations when requested. The status will specify operating software identification, security configurations, applications installed, and capabilities. The attribute attestations will be signed by the media device using the signature keys.

In one embodiment, when the end user wants content, the media device will request the level of trust that is required for the content from the content provider. Alternately, when the end user wants content, the device will request the content at the device's maximum level of trust which may be higher than is required for any specific content. There may be multiple levels of trust specified which equates to different qualities that the content provider is willing to accept. The content provider will sign the trust request and send it back to the media device. The media device will then evaluate whether or not it can provide one or more of the levels requested. If it can meet the trust level requirement for a selected content (a lesser quality must be confirmed by the end user), then the media device will provide its identity attestation along with the status via attribute attestation and the trust request to a trusted third party. Note that a user of the media device can stop the process if the trust level requirement is greater than that which the media device supports. If a user stops the transaction, the user can update the media device and reinitiate the transaction after receiving updated identity and attribute attestations.

Assuming that the user does not stop the process, but continues and sends the identity attestations and attribute (status) attestations along with the required level of trust to the third party, then the trusted third party evaluator, such as an independent third party or a service of the content provider, will evaluate this information and provide the media device (or possibly directly to the content provider identified by the trust request) with a trust level attestation. The media device can then forward this trust attestation to the content provider if the provider doesn't already have it. In one embodiment, the trusted third party will use their authorized signature to sign the trust level attestation. The third party will evaluate the information provided by the media device along with external resources such as vulnerability databases, evaluation criteria, hacking practices, etc. to make the determination of trust level for the content-requesting device. The trust level attestation generated by the third party evaluator will specify the maximum level that the media device can be trusted based upon the trust levels requested. In one embodiment, the media device can then send the determined trust levels to the content provider and request the content. In an alternative embodiment, the determined trust levels could be sent directly to the content provider from the evaluator.

After receiving the trust determined trust level, the content provider will then send the content to the media device based upon the agreed level of trust. If only a lower level of trust can be provided, then the end user can confirm the allowance by selecting a degraded (lower quality) or different version of the selected content. If the third party evaluator denies the media device for the any and/or all levels, then the media device can request instructions from the third party evaluator to help address the denial. The third party provides information to the media device so it can be displayed to the end user to explain why it is being denied the maximum level of trust along with possible remedies. The end user may be able to fix the trust level by updating their media device with newer operating software, removing/adding certain applications, and/or changing security configurations. However, in some cases, the media device just may never be capable of accessing the content.

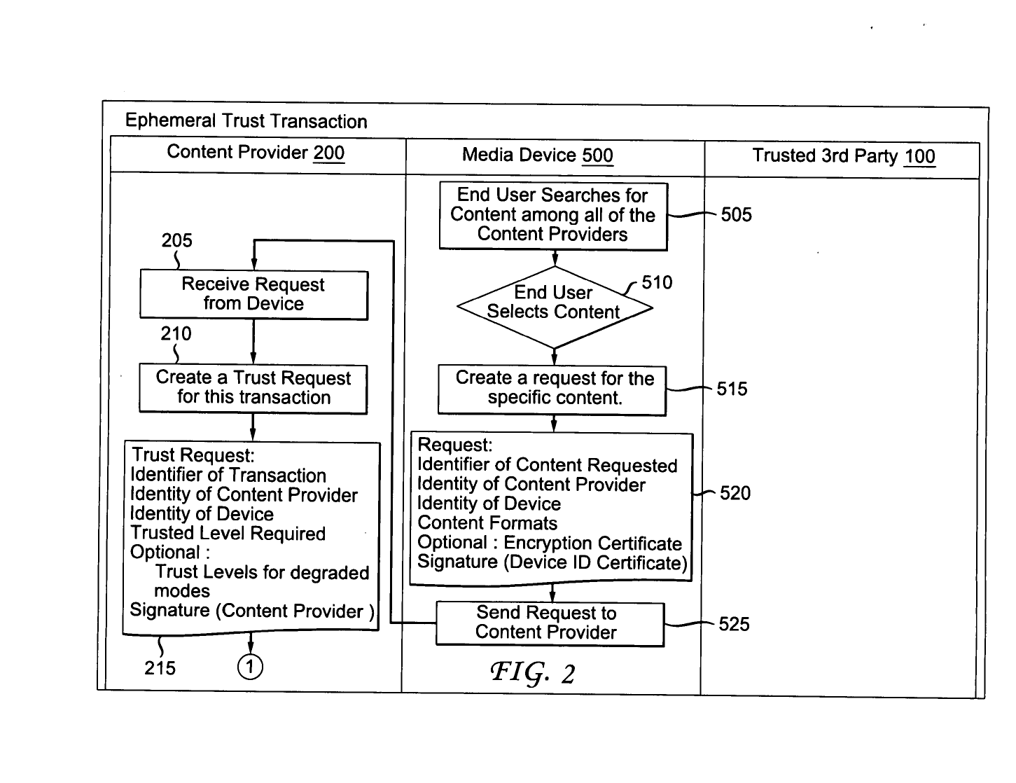

FIGS. 2, 3, and 4 are cascading flow diagrams of one example embodiment which depict an ephemeral trust transaction showing typical transactions between a content provider 200, an media device 500 such as a media device or a media widget, and a trusted third party 100 that provides trusted evaluation services. Also shown in FIGS. 2, 3, and 4 are example aspects of the messages and/or content of the attestations in the example ephemeral trust transaction.

FIG. 2 set 505 is one beginning step for a method according to the present invention. At step 505, a user searches for content from a content provider using an end-user device, such as a media device. Such a search may be interactive as the media device is connected to a content provider via a network service provider. At step 510, a selection is made of specific content via the media device. At the media device, a request for the specific content is made at step 515. In one embodiment, the request may contain the elements of step 520 which include an identifier of the requested content, an identity of the content provider, an identity of the media device, an identity of the end user, and the content format(s) signed by the media device. In some instances, element such as the identity of the content provider and the content format may be optional. Other optional items are encryption keys and attestation or certificate, and the user's identity. The request is then sent to the content provider at step 525.

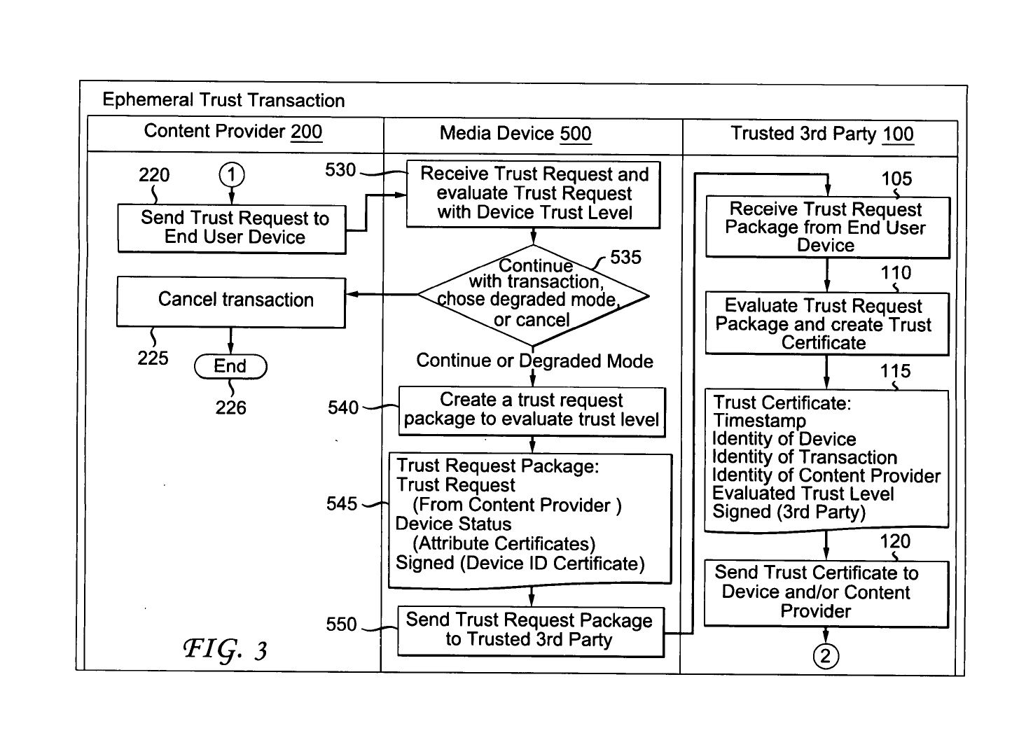

The content provider 200 receives the request for specific content from the media device 500 at step 205. A trust request is then created for this transaction at step 210. In one embodiment, a trust request may contain the elements of step 215 which include an identifier of the transaction, the identity of the content provider, the identity of the device, and the trust level required for the specific content requested by the media device. Optionally, the request could be made for trust levels for degraded modes or versions of the selected content. The trust request will be signed by the content provider using encryption keys. Connector 1 of FIG. 2 leads to FIG. 3 where the flow from the content provider is continued.

On FIG. 3, step 220, the trust request is sent to the media device. At step 530, the media device receives the trust request and evaluates the trust request for the specific content required with the trust level that exists at the media device. The media device may then decide to continue with the transaction selecting the specific content, a degraded mode or version of the content, or to cancel the transaction. If the media device cancels the transaction, step 225 is executed and the transaction ends at step 226. If the media device selects either the original specific content or a degraded mode or version of the content, then step 540 is entered. An example of a degraded mode may be standard definition as compared to a high definition mode. An example of a degraded version of the content may include a trailer or sample of the requested content.

At step 540, a trust evaluation request package is created. In one embodiment, a trust evaluation request package may contain the elements of step 545 which includes the trust request from the content provider, the device status in the form of configuration attestations. Such configuration attestations may take any form including one or more messages or one of more certificates defining attributes of the media device. The trust evaluation request package will be signed by the media device ID attestation, message, or certificate. At step 550, the trust evaluation request package is sent to the trusted third party evaluator 100.

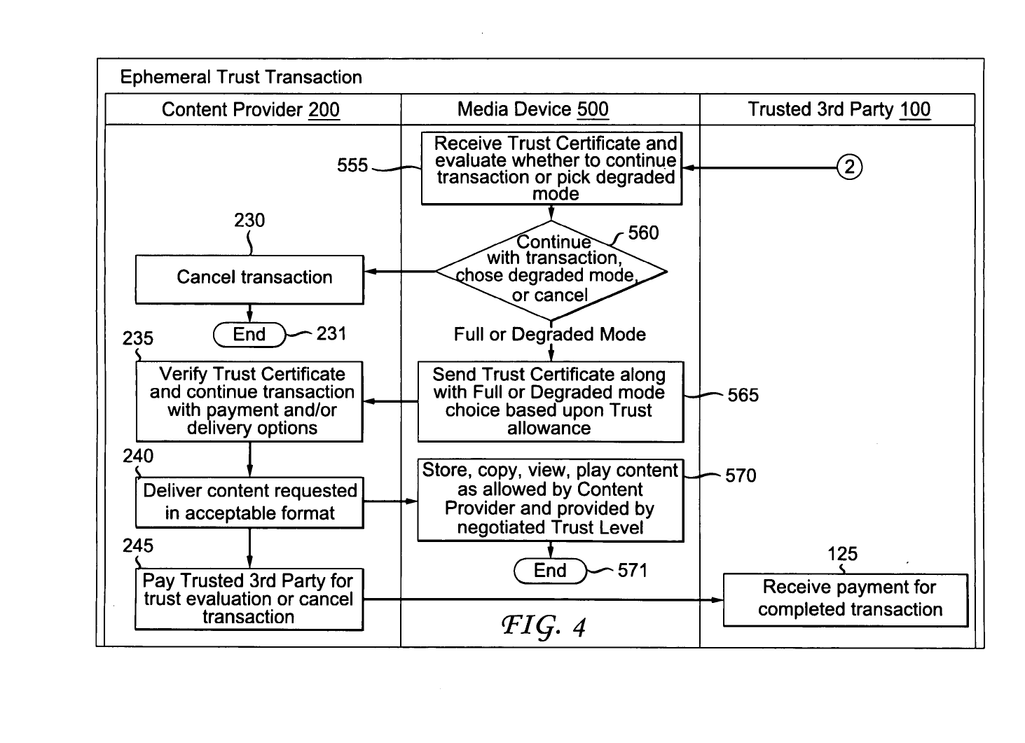

At step 105 of FIG. 3, the trusted third party evaluator receives the trust evaluation request package from the end user. The evaluation of the received trust request package is performed at step 110. The evaluation examines the trust level required placed on the content by the content provider against the level of trust that can be attributed to the media device as a result of the identity of the media device and the attribute attestations of the media device. The result of the evaluation is a trust attestation or message of the media device evaluation. One example of such an attestation or message is a trust certificate as in step 115. Such a certificate can include a timestamp, the identity of the evaluated device, an identification of the transaction, an identity of the content provider, and an evaluated level of trust for the media device corresponding to the evaluation timestamp. The trust certificate will be signed by the third party evaluator using encryption keys. At step 120 the trust certificate is sent to either the user device or the content provider. Connector 2 on FIG. 3 leads to FIG. 4.

Since the transactions represented in FIGS. 2-4 can occur via a network, such as an Internet or Intranet network, then the steps of the on-line transactions can occur quickly as is known to those of skill in the art. Thus, for example, the third party evaluator can receive a trust request package from the media device, evaluate the trust package, generate a trust attestation, such as a trust certificate, and send the evaluated trust level to the media device or content provider (steps 105-120) in rapid succession such that an immediate evaluation of the trust level of the media device compared to the required trust level is provided.

Step 555 of FIG. 4 indicates that the trust certificate issued by the third party evaluator 300 is received by the media device 500. The option of a content provider receiving the trust level certificate is an alternate embodiment, but is not shown. However, if the content provider were to receive the trust level certificate directly from the third party evaluator, the content provider could accept the trust level certificate and deliver the requested content or cancel the transaction. In the instance that the media device receives the trust certificate as shown in step 555, the media device can evaluate whether to continue with the transaction or pick a degraded mode or version of the requested specific content. At step 560, the media device can request the specific content if the evaluated level of trust from the third party evaluator is equal to or higher than the required level of trust from the content provider. Thus, at step 560, the media device can choose to continue with the transaction, choose a degraded form of the specific content, or cancel. This determination by the media device to continue with the transaction or not is based upon the trust level that was evaluated by the third party evaluator and whether the evaluated trust level is sufficient to accommodate the specific content or not. If the trust level certificate received from the third party evaluator indicates an insufficient level of trust for the specific requested content, then the media device may request that the transaction be cancelled by entering step 230 wherein the process ends at step 231. Although not shown in FIG. 4, if the media device is denied access because the evaluated level of trust is less than the required level of trust needed to access content, then the media device may request instructions from the third party evaluator after step 230 to assist in fixing the trust level problem. Such fixes may include but are not limited to upgrading the device operating system, adding or removing applications, and/or changing security configurations. Alternately, if the media device selects that the transaction is to proceed at step 560, with either full or degraded mode of the specific requested content, then step 565 is entered.

At step 565, the trust certificate along with the choice of either full or degraded mode of content is sent to the content provider. At step 235, the content provider receives the trust certificate sent in step 565 and continues the transaction. Step 235 may optionally include providing the media device payment and delivery options which may be interactive with the user device (not shown). At step 240, the content is provided by the content provider in a format compatible with the media device. The media device at step 570 will receive the content and may optionally store, copy, view, or otherwise render the content as allowed by the content provider and as provided according the trust level of the media device. The process then completes for the media device at step 571.

In one possible embodiment, the third party evaluator is sent a payment at step 245 by the content provider. Such payment may be received by the trusted third party evaluator at step 125.

One set of advantages of the ephemeral trust configuration described above is the flexibility of updates to an media device as needed to change levels of trust for specific content. For example, when the user initially acquires a trust level from the content provider that is needed for the specific content, the user can select lower quality content or cancel the transaction. If the user cancels the transaction, the user can upgrade the media device, obtain new attribute attestations, and then achieve a higher level of trust.

Later, when the trust level attestation is received by the third party evaluator, the user again is able to cancel the transaction if it is determined that the originally requested content requires a higher trust level than that provided by the current configuration and status of the media device. As before, the user can either choose a degraded level of content commensurate with the trust level of the trust attestation or cancel the transaction and update the media device to attain a higher level of trust attestation.

Returning to FIG. 1, the media device, as described above, can be any device that is capable of requesting and receiving content from a content provider. The media device 500 uses a network interface 501 for network access. The media device also contains memory 502 for download and program storage, and a processor 503 for interface control, execution of processes defined by the media device portions of flow diagrams of FIGS. 2-4. The memory 502 may contain components, mechanisms, and/or methods that allow for encryption keys to be protected from attackers. The media device 500 also contains a user interface and renderer 504 for presentation of content including audio, video, text, and the like. Although shown combined in FIG. 1, the media renderer may be a separate function than the user interface as is known by those of skill in the art.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

1. A method performed by an apparatus for accessing protected content from a content provider, the method comprising:
(a) receiving an indication of a required level of trust needed to access specific content from a content provider;
(b) supplying an identity attestation, an attribute attestation, and the required level of trust to a trust level evaluator;
(c) receiving from the trust evaluator an evaluated trust level of the apparatus;
(d) determining, whether the specific content can be requested based on the evaluated trust level; and
(e) requesting the specific content from the content provider if the evaluated trust level meets the required level of trust needed to access the specific content.

2. The method of claim 1, wherein the step of determining further includes determining what mode or version of the specific content can be downloaded if the evaluated trust level is lower than the required level of trust needed to access the specific content.

3. The method of claim 2, further comprising:
(f) requesting a different mode or version of the specific content if the evaluated trust level is lower than the required level of trust to access the specific content.

4. The method of claim 2, further comprising:
(f) requesting no content if the evaluated trust level is lower than the required level of trust to access the specific content.

5. The method of claim 2, further comprising:
(f) requesting an update to the apparatus to attain a higher level of trust if the evaluated trust level is lower than the required level of trust to access the specific content; and
(g) repeating steps (b-e).

6. The method of claim 2, further comprising:
(f) requesting instructions to address a vulnerability to attain a higher level of trust if the evaluated trust level is lower than the required level of trust to access the specific content; and
(g) repeating steps (b-e).

7. The method of claim 1, wherein the trust level evaluator is one of a third party evaluator, a content provider, a certificate authority, a media device manufacturer, or a network service provider.

8. An apparatus for accessing protected content from a content provider, the apparatus comprising:
a network interface for connecting to a content provider and an evaluator of trust level;
a user interface for user control;
a processor to request an attestation of an evaluated trust level of the apparatus from a trust evaluator that determines a level of trust based on an identity attestation, an attribute attestation, and a required level of trust provided by the apparatus, the processor also requesting the protected content if the evaluated trust level is equal to or higher than the required level of trust;
a memory for storage of encryption keys and the protected content that is downloaded from the content provider.

9. The apparatus of claim 8, wherein the apparatus comprises a media renderer.

10. The apparatus of claim 9, wherein the media renderer acts to render any of audio, video, and text information.

11. The apparatus of claim 8, wherein the required level of trust is generated by a content provider in response to a request for specific content.

12. The apparatus of claim 8, further comprising a media renderer for that plays the downloaded protected content.

13. The apparatus of claim 8, wherein the processor requests a different version of the specific content if the evaluated trust level is lower than the required level of trust needed to access the specific content.

14. The apparatus of claim 8, wherein the processor requests an update to the apparatus to attain a higher level of trust if the evaluated trust level is lower than the required level of trust to access the specific content.

15. The apparatus of claim 8, wherein the processor requests instructions to address a vulnerability to attain a higher level of trust if the evaluated trust level is lower than the required level of trust to access the specific content.
